(19) United States
(12) Patent Application Publication
(10) Pub. No.: US 2006/0012248 A1
(43) Pub. Date: Jan. 19, 2006

(54) Electric power control device for watercraft

(76) Inventors: Yukio Matsushita, Shizuoka-ken (JP); Takao Kawai, Shizuoka-ken (JP); Noboru Kobayashi, Shizuoka-ken (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/181,568

(22) Filed: Jul. 14, 2005

(30) Foreign Application Priority Data
Jul. 14, 2004 (JP) 2004-206801

(51) Int. Cl. B60L 1/00

(52) U.S. Cl. 307/10.1

(57) ABSTRACT

An electric power control device can have multiple fuel cells, loading devices driven by the electric power supplied by the multiple fuel cells, and a control device for operating the fuel cells in response to the electric power load required by the loading devices. The control device can have an efficiency characteristics recognition device for recognizing the efficiency characteristics for each of the multiple fuel cells, an electric power requirement recognition device for recognizing the electric power required by the loading devices, and a fuel cell operation control device for controlling the operation of the fuel cells so that the efficiency characteristics get closer to the maximum efficiency loading point in response to the recognized electric power requirement.

### PRIORITY INFORMATION

This application is based on and claims priority under 35 U.S.C. § 119 to Japanese Patent Application No. 2004-206801, filed on Jul. 14, 2004, the entire contents of which is hereby expressly incorporated by reference.

### BACKGROUND OF THE INVENTIONS

1. Field of the Inventions

The present inventions relate to control devices for relatively small watercraft such as motorboats, pontoon boats, house boats, and other types of watercraft. More specifically, the present inventions relate to an electric power control device for supplying the electric power to loading devices by means of multiple fuel cells.

2. Description of the Related Art

Conventionally, fuel cells are known to be applied to automobiles, domestic electric appliances, mobile equipment and others as an electric power supply device. Fuel cells also frequently appear in various periodicals including magazines. However, such fuel cells are generally utilized within a particular unit produced by a manufacturer, with the fuel cells being custom made for a driving system that is the core of that particular system. For example, Japanese Patent Publications JP-A-2000-217275 (Pages 1 through 7, FIGS. 1 through 4), and JP-A-2001-501018 (Pages 1 through 35, FIGS. 1 through 4) disclose such fuel cell-driven systems.

### SUMMARY OF THE INVENTIONS

In the field of relatively small watercraft, the hulls, propulsion units such as outboard motors or inboard/outboard stem drives, and a plurality of other devices, each of which may come from different manufacturers, are combined to form the complete watercraft. When fuel cells are used as a power source in a relatively small watercraft, the expandability and diversification of the watercraft system is hindered, because the power provided by the fuel cell system may become insufficient when additional auxiliary and electric appliances are added, or if a twin installation of outboard motors is employed.

Thus, in accordance with an embodiment, an electric power control device for a watercraft is provided. The power control device can comprise at least first and second fuel cells configured to generate electric power, a plurality of loading devices driven by the electric power supplied by the multiple fuel cells, and a control device configured to operate the fuel cells in response to an electric power load generated by the loading devices. The control device can comprise an efficiency characteristics recognition device configured to recognize the respective efficiency characteristics for each of the first and second fuel cells. The control device can also comprise an electric power requirement recognition device configured to recognize the electric power required by the loading devices. Further, the control device can also comprise a fuel cell operation controller configured to control the operation of the fuel cells so that the operational efficiency of at least one of the first and second fuel cells changes toward the maximum efficiency loading point according to the efficiency characteristics in response to the recognized electric power requirement.

In accordance with another embodiment, an electric power control device for a watercraft is provided. The power control device can comprise at least first and second fuel cells configured to generate electric power, a plurality of loading devices driven by the electric power supplied by the multiple fuel cells, and a control device configured to operate the fuel cells in response to an electric power load generated by the loading devices. The control device can comprise an efficiency characteristics recognition device configured to recognize the respective efficiency characteristics for each of the first and second fuel cells, and an electric power requirement recognition device configured to recognize the electric power required by the loading devices. Additionally, the control device can comprise means for fuel cell operation for controlling the operation of the fuel cells so that the operational efficiency of at least one of the first and second fuel cells changes toward the maximum efficiency loading point according to the efficiency characteristics in response to the recognized electric power requirement.

### BRIEF DESCRIPTION OF THE DRAWINGS

The above-mentioned and the other features of the inventions disclosed herein are described below with reference to the drawings of the preferred embodiments. The illustrated embodiments are intended to illustrate, but not to limit the inventions. The drawings contain the following figures:

FIG. 1 is a schematic side elevational view of a watercraft provided with an electric power control device.

FIG. 2 is a schematic diagram of the electric power control device in the watercraft of FIG. 1.

FIG. 3 is an illustration showing an exemplary efficiency characteristic of fuel cells that can be used with the electric power control device in the watercraft of FIG. 2.

### DETAILED DESCRIPTION OF THE PREFERRED EMBODIMENT

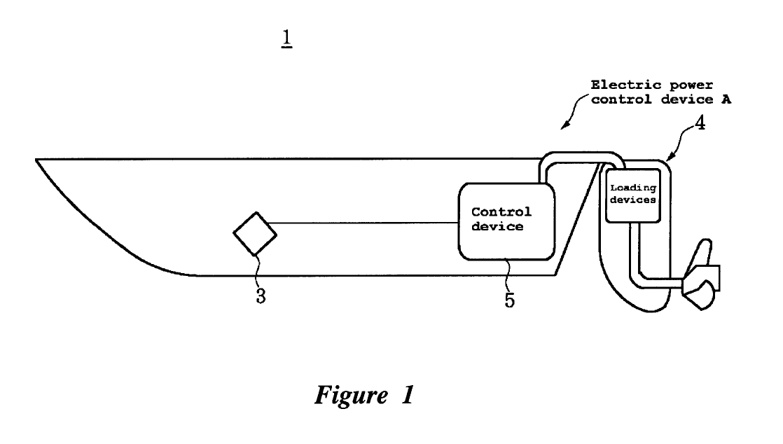

FIG. 1(a) is a side elevational view of a small watercraft 1 having a controller in accordance with an embodiment. The embodiments disclosed herein are described in the context of a small watercraft because the embodiments disclosed herein have particular utility in this context. However, the embodiments and inventions herein can also be applied to other boats having other types of propulsion units as well as other types of vehicles.

As used herein, the terms “front,” “rear,” “left,” “right,” “up” and “down,” correspond to the direction assumed by a driver of the watercraft.

The watercraft 1, in some embodiments, is equipped with an electric power control device A. The electric power control device A can have multiple fuel cells 3, loading devices 4 driven by the electric power supplied by the multiple fuel cells 3, and a control device 5 for operating the fuel cells 3 in response to the electric power load required by the loading devices 4.

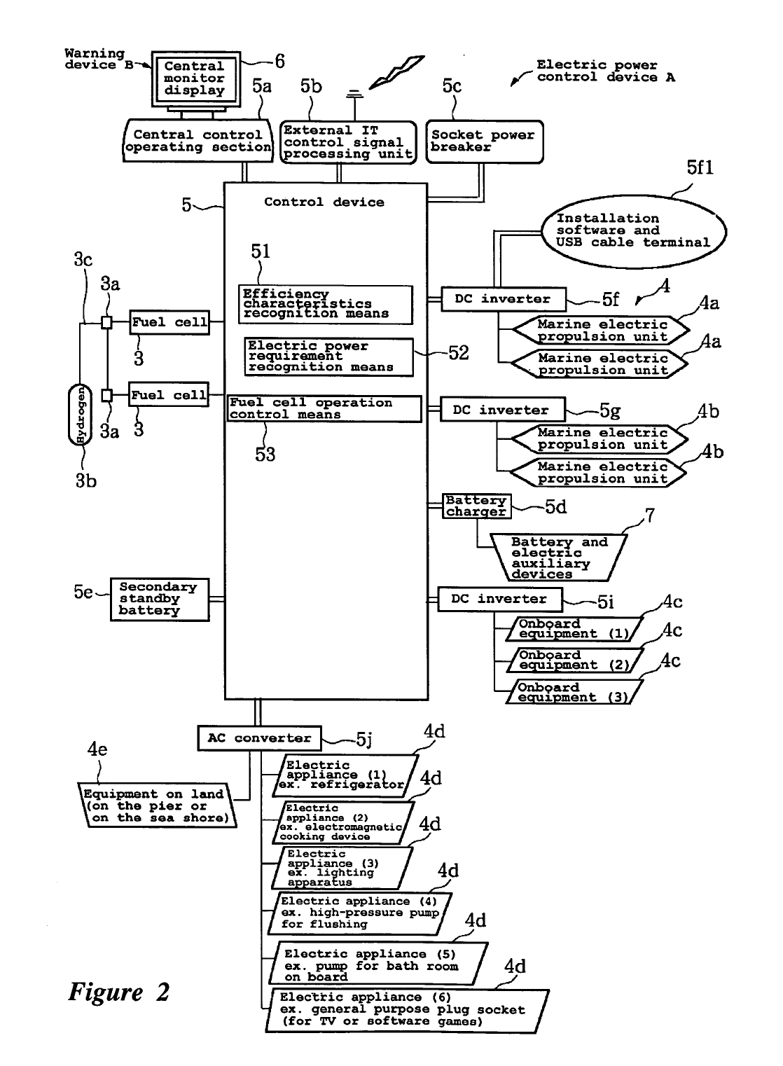

The structure of the electric power control device A is described with reference to FIG. 2, which is a schematic diagram of the electric power control device. Fuel supply sections 3a can be provided for each respective fuel cell 3. In the illustrated embodiment, there are two fuel cells 3. However, other numbers of fuel cells can also be used.

The control device A is configured to manage the fuel supply sections 3a using the control device 5. Fuel composed of the mixture of hydrogen and air can be delivered to the fuel cells 3, and the fuel cells 3 can thus generate electrical power. The fuel cells 3 can have modular structures to facilitate the installation of additional fuel cells. The fuel supply sections 3a can be provided with a regulator, pressure gage, and so on, so that it can supply fuel to the fuel cells 3 at specified pressure.

The control device 5 can be connected with a central control operating section 5a, an external IT control signal processing unit 5b, a socket power breaker 5c, a battery charger 5d, and a secondary standby battery 5e. However, the control device 5 can also have other components. The control device is further connected with the loading devices 4.

The central control operating section 5a can be composed of operating buttons, keyboards, and other parts for carrying out the centralized monitoring and manual control operations. Operation by means of the central control operating section 5a allows data such as; electric power level, power generation output, current running load, socket ON/OFF, daily and monthly accumulated operating hours, notice of maintenance requirements, and/or other data; to be displayed on the screen of an central monitor display 6. The central monitor display 6 constitutes a display device, such as a liquid crystal or other type of display device, configured to indicate the electric power load required by the loading devices 4, as well as the electric power supply by the fuel cells 3.

The external control signal processing unit 5b can be configured to receive coastal and port area navigation radio signals, and/or GPS radio signals to achieve safety navigation and automatic navigation.

In the case of pleasure boat using a main boat and a sub-boat which is connected to the main boat to obtain the electric power supply from it, the electric power control device A can be installed on the main boat. In such embodiments, a battery mounted on the sub-boat 7 can be charged at any time by means of the battery charger 5d provided on the main boat.

The loading devices 4 can include a marine electric propulsion unit 4a, an electrically operated auxiliary propulsion unit 4b, onboard equipment 4c, an electric appliance 4d, and equipment 4e on land (on the pier or on the sea shore), and/or other equipment.

Multiple marine electric propulsion units 4a can be connected to the control device 5 by means of a DC inverter 5f. The marine electronic propulsion unit 4a can be replaceable, and additional units can also be connected at a later time. The DC inverter 5f can also be replaceable depending on the capacity and the number of marine electric propulsion unit 4a. The DC inverter 5f can be equipped with installation software and a USB cable terminal 5f1, or other types of terminals, allowing the easier upgrading of the devices.

Multiple electrically operated auxiliaries 4b can be connected to the control device 5 by means of a DC inverter 5g. The electrically operated auxiliary 4b can include a thruster and an auto-spanker.

The onboard equipment 4c can be connected to the control device 5 by means of a DC inverter 5i. The onboard equipment 4c can also include a fishfinder.

The electric appliances 4d can be connected to the control device 5 by means of an AC converter 5j. The electric appliances 4d can include a TV, a refrigerator, an electric range, a lighting apparatus, a high-pressure pump for flushing, a pump for the bath room on board, a general purpose plug socket, or other devices, some of which provide a residential comfort just like the conditions at home.

In addition, when the electric power control device A is installed on a temporary mobile barge, the equipment on land (on the pier or on the sea shore) 4e can be connected to the control device 5 by means of the AC converter 5j, enabling the electric power to be supplied by the temporary mobile barge to the equipment on land.

Also, the multiple fuel cells 3 and the loading devices 4 can be connected to the control device 5. Since a variety of module types are available for the fuel cell 3, and the modules of the fuel cell 3 are supplied by various manufacturers, an identification mark is attached in advance to the components such as modules of the fuel cells 3, the marine electric propulsion unit 4a, the electrically operated auxiliary. 4b, the onboard equipment 4c, and the electric appliance 4d. Once they are connected to the control device 5, the control device 5 can read out the signals including the identification marks. The signals including the identification mark can be been registered in advance in the control device 5. Also, the performance, the characteristics, and other factors can be input and registered in the control device 5.

The system is configured so that the read-out signals are compared with the registered data within the control device 5, and once the signals match the registered data, the components are controlled automatically. This enables enhanced control, and can eliminate the concern for the possible system failure by connecting the devices not covered by the warranty without having an identification mark.

The configuration for connecting the multiple fuel cells 3 and the loading devices 4 to the control device 5 can include a power cable connected to supply the electric power. In addition, an independent control cable can be connected to read out the signals including the identification marks and to transmit the signals for controlling the fuel cells 3. A USB connector used on commercially available personal computers (PCs) can be employed for connecting the control cable. Windows®-based software can also be installed in the control device 5, which is configured to display “New hardware is detected” on the screen when the control cable is connected. Then, a set-up wizard can be activated to complete the set up by simple operation. The set up system can be similar to that used for the PC printers and for installing the additional PC peripheral devices.

The set-up and operations procedures for the control device 5 can be similar to those for the PCs. Users and dealers can complete the set up easily without the need for much expertise. Connected devices can be managed based on the identification signals. Electric power supply system employing the fuel cells as the power source can thus be configured easily.

The equipment related to the loading devices 4 can include the battery charger 5d. When the electric power control device is installed on the main boat, while the battery, the battery charger 5d, and the electrically operated auxiliary are installed on the sub boat and are connected to supply the charged power, for instance, device identification of the battery charger 5d, as well as its performance characteristics can be input and registered in the control device. In this way, the battery charger 5d can be included in the module control elements of the fuel cell 3.

Also, the secondary standby battery 5e, intended for securing the reserved power, and also intended to serve as a power source capacity damper, can be connected to the control device 5. The control device 5 can be configured to balance-out the electric power generated by the modules of the fuel cell 3, the electric power consumption by the loading devices 4, and the temporary power storage in the secondary standby battery 5e.

The control device 5 can comprise a CPU, RAM, ROM, and other parts. The control device 5 can have an efficiency characteristic recognition device 51 configured to recognize the efficiency characteristics of each of the multiple fuel cells 3. The control device 5 can also have an electric power requirement recognition device 52 configured to recognize the electric power required by the loading devices. In some embodiments the control device 5 can have a fuel cell operation control device 53 configured to control the operation of the fuel cells 3 so that the efficiency characteristics get closer to the maximum efficiency loading point in response to the recognized electric power requirement.

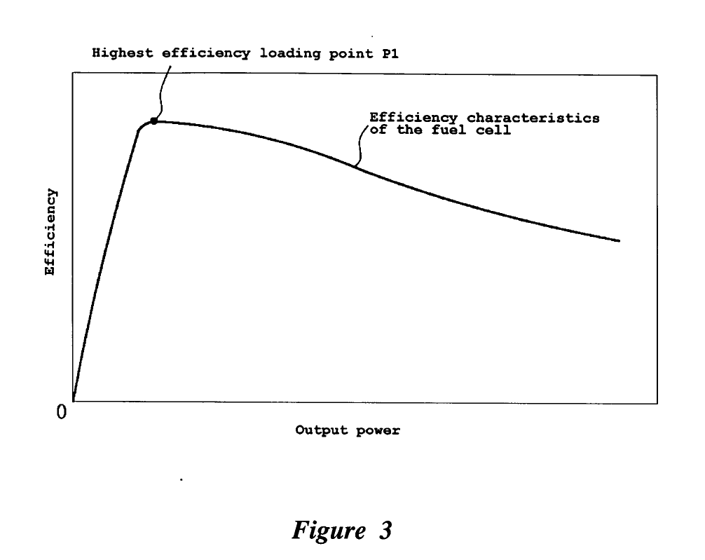

The fuel cells 3 can have the exemplary efficiency characteristic shown in FIG. 3. IN some embodiments, the efficiency characteristics of the fuel cells 3 can be stored in the memory in advance.

The efficiency characteristics recognition device 51 can be configured to recognize the efficiency characteristics of the fuel cells 3 which have been stored in the memory. The fuel cell operation control device 53 can be configured to control the operation of the fuel cell 3 in the manner such that the operation thereof gets closer to the maximum efficiency loading point P1 in response to the electric power requirement recognized by the electric power requirement recognition device 52.

In such embodiments, the electric power requirement recognition device 52 detects the load of the connected loading devices 4 as they are activated, and automatically recognizes the required electric power. The electric power requirement recognition device 52 can be configured, however, to receive information data stored in the connected loading devices 4, such as their type and the loading capacity, and to recognize the required electric power based on the information data automatically. Using this arrangement, additional loading devices 4 can be installed depending on the application by the user.

As indicated by the maximum efficiency loading point P1 of the efficiency characteristic shown in FIG. 3, the fuel cell 3 has a maximum energy conversion efficiency point that lies in the low to mid-loading range. Multiple fuel cells 3 can be operated effectively regardless of the number and kind of the loading devices 4, by controlling the operation of the fuel cell 3 in the manner that the efficiency characteristic gets closer to the maximum efficiency loading point P1 in response to the recognized electric power requirement.

For instance, a unit of the fuel cell 3 can be made into a module (all fuel cell attachments are central except for hydrogen fuel storage 3b and a piping 3c). Then, in the situation that the modules of multiple fuel cells 3 and the marine electric propulsion unit 4a, the electrically operated auxiliary propulsion unit 4b, onboard equipment 4c, electric appliance 4d, and so on are mounted on the watercraft 1, the operating condition of the multiple fuel cells 3 are controlled automatically so that each of the fuel cells 3 is operated to get closer to the maximum efficiency loading point P1 of the energy conversion efficiency.

For example, when the watercraft 1 is equipped with three outboard motors accompanied by the modules of three fuel cells 3 for operating the marine electric propulsion unit 4a of the three outboard motors, the three fuel cells 3 are operated at the point near the maximum efficiency loading point P1.

Further, a watercraft 1 with two outboard motors can be provided with the modules of three fuel cells 3 and the marine electric propulsion unit 4a for each of the two outboard motors, and further mounted with electrically operated auxiliary propulsion unit 4b, onboard equipment 4c, electric appliance 4d, and so on. In such an arrangement, the modules of three fuel cells 3 are operated at the maximum output power during the maximum loading operation of such equipment.

In some embodiments, the watercraft 1 can have three outboard motors with the modules of three fuel cells 3 for operating the marine electronic propulsion unit 4a of the three outboard motors. In such an arrangement, as the heavy load operation of marine electronic propulsion unit 4a is changed into the medium or light load operation, the calculation can be made in response to-the change so that the total efficiency of the modules of three fuel cells 3 becomes closer to the maximum point. Then, the loading on the fuel cells 3 is adjusted automatically by sending the control signals to the modules of the fuel cells 3.

The control device 5 can be configured to detect the loads of the marine electric propulsion unit 4a and so on, to carry out the calculation to adjust the loading, and to transmit the optimized running output signal, for operating the fuel cells 3 under the optimum conditions.

In this way, when the modules of the multiple fuel cells 3 are installed, it is automatically controlled to obtain the maximum energy conversion efficiency all the time. Thus, the fuel consumption can be maintained at the lowest level. In addition, detailed response can be made to comply with the conditions of application by the user. Additional installation of the fuel cells 3 and the loading devices 4 can also be made more easily.

Further, in some embodiments, efficiency characteristics of the connected fuel cells 3 can be recognized automatically. Thus, even an additional fuel cell 3 can be automatically incorporated in the system of electric power control device A as it is connected, resulting in the enhanced expandability and diversification of the system.

Optionally, the electric power control device A can be provided with a warning device B that is configured to issue a warning when loading devices 4 having the loading requirement in excess of the maximum power supply capacity of the fuel cell 3 is connected. The warning device B can be composed of the central monitor display 6, for instance, and can include flashing a warning sign on the display. Optionally, the warning device B can comprise a buzzer or other elements. As a warning is given for the loading requirement in excess of the maximum power supply capacity of the fuel cell 3, the user can stop some of the loading devices 4 in such case. Thus, the devices are protected and the durability of the fuel cell 3 is improved.

In addition, in case the maximum power supply capacity of the fuel cell is exceeded, the fuel cell operation control device 53 can be configured to automatically stop the predetermined loading devices 4 after giving a warning. Thus, the operation can be controlled to prevent the degradation of output power or the stall of the marine electric propulsion unit 4a.

Also, the control device 5 can be configured to receive GPS radio signals and the coastal/port area public navigation safety signals. Thus, the function can be added to check the signals in comparison with the data such as marine chart incorporated in the control device 5. Also the function of transmitting the signal for controlling the steering of the marine electric propulsion unit 4a can be added.

Further, the control device 5 has operation management function by which the operating conditions of the fuel cell 3 and its operation at the maximum efficiency are displayed in the graphical form. Also, the fuel level, the electric power level, and monthly accumulated values are calculated and displayed.

Moreover, the control device 5 can be provided with the emergency service system in which the emergency devices can be connected in case of emergency or for the rescue in an accident without the registration of the identification signal for distinguishing each device, and once connected, the higher operating priority is given to the emergency devices.

The embodiments disclosed herein include multiple fuel cells, loading devices driven by the electric power supplied by the multiple fuel cells, and a control device for operating the fuel cells in response to the electric power load required by the loading devices. The control device controls the operation of the fuel cell in the manner that the efficiency characteristics get closer to the maximum efficiency loading point in response to the recognized electric power requirement, achieving the efficient operation of the multiple fuel cells regardless of the number and the sorts of the loading devices.

For example, during operation, all of the fuel cells 3 can be operating near peak efficiency, according to their corresponding efficiency characteristics, and then one or more of the loading devices can be powered off. The drop in load might cause the power output of all of the fuel cells to drop sufficiently to cause their efficiencies to drop away from the peak efficiency level. In this situation, the control device 5 can use any one of a number of techniques to operate one or more of the fuel cells 3 at a higher efficiency. For example, in this situation, the control device 5 can be configured to raise the power output of all of the fuel cells 3 and use the excess power to re-charge any battery that is not fully charged. In another scenario, the control device 5 can shut down one of the fuel cells 3, thereby allowing the other fuel cells 3 to continue running at a higher load and thus at higher efficiencies. Other techniques are also possible.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. An electric power control device for a watercraft, the power control device comprising at least first and second fuel cells configured to generate electric power, a plurality of loading devices driven by the electric power supplied by the multiple fuel cells, and a control device configured to operate the fuel cells in response to an electric power load generated by the loading devices, the control device comprising an efficiency characteristics recognition device configured to recognize the respective efficiency characteristics for each of the first and second fuel cells, an electric power requirement recognition device configured to recognize the electric power required by the loading devices, and a fuel cell operation controller configured to control the operation of the fuel cells so that the operational efficiency of at least one of the first and second fuel cells changes toward the maximum efficiency loading point according to the efficiency characteristics in response to the recognized electric power requirement.

2. The electric power control device for watercraft according to claim 1, wherein the efficiency characteristic recognition device is configured to automatically recognize the efficiency characteristics of the connected fuel cells.

3. The electric power control device for watercraft according to claim 1, wherein the electric power requirement recognition device is configured to detect a load of the connected loading devices, and to automatically recognize the required electric power.

4. The electric power control device for watercraft according to claim 1, wherein the electric power requirement recognition device is configured to receive information data stored in the connected loading devices, and to recognize the required electric power automatically based on the information data.

5. The electric power control device for watercraft according to claim 1, wherein the loading devices comprise marine electric propulsion units.

6. The electric power control device for watercraft according to claim 2, wherein the loading devices comprise marine electric propulsion units.

7. The electric power control device for watercraft according to claim 3, wherein the loading devices comprise marine electric propulsion units.

8. The electric power control device for watercraft according to claim 4, wherein the loading devices comprise marine electric propulsion units.

9. The electric power control device for watercraft according to claim 1, further comprising a warning device configured to provide a warning when a loading device having a loading requirement in excess of a maximum power supply capacity of the fuel cells is connected.

10. The electric power control device for watercraft according to claim 2, further comprising a warning device configured to provide a warning when a loading device having a loading requirement in excess of a maximum power supply capacity of the fuel cells is connected.

11. The electric power control device for watercraft according to claim 3, further comprising a warning device configured to provide a warning when a loading device having a loading requirement in excess of a maximum power supply capacity of the fuel cells is connected.

12. The electric power control device for watercraft according to claim 4, further comprising a warning device configured to provide a warning when a loading device having a loading requirement in excess of a maximum power supply capacity of the fuel cells is connected.

13. The electric power control device for watercraft according to claim 5, further comprising a warning device configured to provide a warning when a loading device having a loading requirement in excess of a maximum power supply capacity of the fuel cells is connected.

14. The electric power control device for watercraft according to claim 1, wherein the fuel cell operation control device is configured to automatically stop predetermined loading devices after providing a warning.

15. The electric power control device for watercraft according to claim 1, further comprising a display device configured to indicate the electric power load required by the loading devices, and the electric power supply by the fuel cells.

16. An electric power control device for a watercraft, the power control device comprising at least first and second fuel cells configured to generate electric power, a plurality of loading devices driven by the electric power supplied by the multiple fuel cells, and a control device configured to operate the fuel cells in response to an electric power load generated by the loading devices, the control device comprising an efficiency characteristics recognition device configured to recognize the respective efficiency characteristics for each of the first and second fuel cells, an electric power requirement recognition device configured to recognize the electric power required by the loading devices, and means for fuel cell operation for controlling the operation of the fuel cells so that the operational efficiency of at least one of the first and second fuel cells changes toward the maximum efficiency loading point according to the efficiency characteristics in response to the recognized electric power requirement.
